(19) United States
(12) Patent Application Publication
(10) Pub. No.: US 2019/0026749 A1
(43) Pub. Date: Jan. 24, 2019

(54) SECURITY TAG AND ELECTRONIC SYSTEM USABLE WITH MOLDED CASE CIRCUIT BREAKERS

(71) Applicant: EATON CORPORATION, CLEVELAND, OH (US)

(72) Inventors: Zhi Gao, Warrendale, PA (US); Theodore J. Miller, Oakdale, PA (US); Timothy F. Thompson, Pittsburgh, PA (US); Randy P. Shvach, Conway, PA (US); Daniel A. Hosko, Pittsburgh, PA (US)

(73) Assignee: EATON CORPORATION, CLEVELAND, OH (US)

(21) Appl. No.: 15/652,540

(22) Filed: Jul. 18, 2017

(51) Int. Cl. G06Q 30/00; G08B 13/24; G06K 19/10; G06K 7/10

(52) U.S. Cl. CPC G06Q 30/018; G08B 13/2462; G06Q 2220/00; G06K 7/10297; G06K 19/10

(57) ABSTRACT

A security tag and electronic system detect unauthorized tampering of Molded Case Circuit Breakers (MCCBs) and authenticate MCCBs against counterfeiting or gray market items. The system can involve digital generation of a public key and a corresponding private key, both keys comprise large positive integers, applying the private key to an MCCB-specific message string and creating a digital signature code, generating an identification code from the MCCB-specific message string and the digital signature code, building the identification code into one or more security tags, and installing the security tags on MCCBs, and authenticating MCCBs through a verification step and a certification step. The verification step reads the security tags, and verifies the identification code. The certification step checks the identification code against a revocation list that contains previously compromised identification codes.

### BACKGROUND

### Field

The present invention describes a security tag and electronic system structured to detect unauthorized tampering of molded-case circuit breakers (MCCBs) and authenticate MCCBs against counterfeiting or gray market items and, more particularly, the security tag and electronic system are related to digitally generating paired public and private keys, applying the private key and creating a digital signature code, generating an identification code and building it into one or more security tags to attach to MCCBs, and authenticating MCCBs through a verification step and a certification step based on the identification code in the one or more security tags and the public key.

### Related Art

Molded-case circuit breakers (MCCBs) and other circuit interruption devices are designed to provide circuit protection for power distribution systems. They safeguard connected electrical devices against current overloads and short circuits. They protect people and equipment in the field.

MCCBs purchased from unauthorized online resellers and unauthorized local dealers are often of unknown conditions and origins. Those MCCBs, despite being frequently advertised as “new,” may turn out to be reconditioned or altered. They may even be counterfeit products that are mixed with genuine MCCBs. Even for genuine MCCBs, they may be sold outside an original MCCB manufacturer's authorized reseller channels, i.e., in gray market commerce, and thus void any product warranty and services offered by the original MCCB manufacturer. It is obvious that the sourcing practices of unauthorized resellers and brokers expose users to substantial risks of lost production revenues, as well as potential risks and liability (National Electrical Manufacturers Association, Authentication Technologies for Brand Protection, https://www.nema.org/Policy/Anti-Counterfeiting/Documents/Authentication_Technologies_for_Brand_Protection_4web.pdf).

### Tampering

MCCBs are not designed for modification, service, or refurbishing outside of the original MCCB manufacturer operated facilities. Unfortunately the practice of third-party reconditioning, using scavenged or counterfeited parts, is widespread in many places. This type of product tampering also often involves removal of the original MCCB manufacturer's marks, such as date codes, lot codes, serial numbers, universal product codes (UPCs), etc., and re-labeling of those marks with fake ones, in an effort to disguise the source or age of the reconditioned or altered MCCBs.

### Counterfeits

Counterfeit MCCBs refer to either newly manufactured fake MCCBs, or refurbished genuine MCCBs with counterfeit packaging, marks, or labeling. They are produced with the intent to take advantage of the superior value of the new and genuine MCCB products.

The proliferation of counterfeit MCCBs affects almost all well-known MCCB manufacturers in the electrical industry. Counterfeit MCCBs are hard to spot, and thus often avoid detection. Because they are inherently unsafe, the counterfeit MCCBs pose a real safety hazard to any site where they are installed and put users at risk.

### Gray Market

A gray market of MCCBs refers to the sale of genuine MCCBs by independent resellers or dealers who do not have formal distribution agreements with the original MCCB manufacturer. MCCBs purchased from gray market resellers may be new but may have been acquired through channels outside of normal authorized distribution channels and policies, and thus do not come with original MCCB manufacturer's standard warranty and services. Due to sourcing practices, MCCBs purchased from a gray market reseller are also more likely to receive old surplus, scavenged or reconditioned products. Because of this reason, MCCBs purchased from gray market resellers may put customer's health and safety at risk.

### Challenges Using Conventional Authentication Systems and Methods

Tampered, counterfeit, and gray-market MCCBs are hard to spot. Ordinary users may not have sufficient technical knowledge and experience to authenticate those MCCBs or detect any unauthorized product tampering. Presently, ordinary users rely on date code, quality and process control (QPC) code, labeling, and a combination of those data to authenticate those MCCBs or detect unauthorized product tampering.

### Authentication Via Date Code

The original MCCB manufacturer often stamps the date of manufacture, i.e., date code, on the MCCBs. For example, the date code is often stamped along with other product-related information on the front of an MCCB.

For tampered, counterfeit, and gray-market MCCBs, this date code is removed to hide the age of the MCCB. This is because any product over two years old no longer has any factory warranty unless specified otherwise.

### Authentication Via OPC Code

The QPC code is used by the original MCCB manufacturer in manufacturing process to ensure product quality. The QPC code is often a bar code label along with a numeric code that contains the MCCB's quality-related information at the time of manufacture. This bar code allows identification through commerce. For tampered, counterfeit, and gray-market MCCBs, this QPC code is often missing or forged.

### Authentication Via Labeling

The labeling is another method to authenticate MCCBs. The following is a list of commonly used methods to identify non-genuine MCCBs.
Factory seals broken or removed. This indicates that product has been tampered with. Therefore, the product has no warranty or guarantee that it meets performance specifications.
Mislabeled products to change size/type. This indicates that product has been tampered with, causing a possible misapplication and a safety hazard.
Missing Underwriters Laboratories (UL) sticker. This indicates that the product is likely imported illegally and is not certified to meet U.S. national electrical codes.
Low-quality labeling and/or misspelled words. This indicates that product is likely a counterfeit and made with substandard materials and workmanship.

### Authentication Via Circuit Breaker Authentication Tools

Some MCCB manufacturers use circuit breaker authentication tools to authenticate their MCCBs. The circuit breaker authentication tools often use a combination of MCCB's style number, date code and QPC code to authenticate. The style number is a string of alphanumeric characters from the original MCCB manufacturer's catalog that shows MCCB information, such as voltage rating, interrupting current rating, etc. For example, a style number of Eaton 6629C90G16 is associated with an Eaton Series C, F-frame MCCB.

While it is useful to authenticate MCCBs using date code, QPC code, labeling, or a combination of various data, it still requires users to have a high level of understanding of such codes and labels. Unauthorized third-party may affix labeling from other salvaged genuine MCCBs to the tampered MCCBs to avoid being detected. It is often difficult for ordinary users to identify forged codes or labeling without spending a tremendous amount of effort. Improvement thus would be desirable.

### SUMMARY

An improved security tag and electronic system detect unauthorized tampering of MCCBs and authenticate MCCBs against counterfeiting or gray market items. The security tag and electronic system can be generally said to involve a number of operations. As employed herein, the expression “a number of” and variations thereof shall refer broadly to an non-zero quantity, including a quantity of one. The steps can include:
digital generation of paired public and private keys—the paired public and private keys include a public key and a corresponding private key wherein both keys comprise large positive integers;
applying the private key to an MCCB-specific message string and creating a digital signature code;
generating an identification code from the MCCB-specific message string and the digital signature code, building the identification code into one or more security tags, and installing the security tags on MCCBs;
authenticating MCCBs through a verification step and a certification step. The verification step reads the security tags, and verifies the identification code. The certification step checks the identification code against a revocation list that contains previously compromised identification codes.

Accordingly, an aspect of the disclosed and claimed concept is that by incorporating the digital signature code into the MCCB, this invention provides traceability of original MCCB manufacturer's products.

Another aspect of the disclosed and claimed concept is that successful verification and certification give users confidence to trust the MCCBs' integrity and authenticity.

Another aspect of the disclosed and claimed concept is that users can further detect whether the MCCBs are potential gray market items by examining the contents of valid identification codes.

Another aspect of the disclosed and claimed concept is that it helps reduce the amount of effort that ordinary users have to spend when determining the MCCB's integrity and authenticity.

Another aspect of the disclosed and claimed concept is that it helps reduce or eliminate risks, liabilities, safety- and performance-related issues, and even a complete business shutdown that may occur when using tampered, counterfeit or gray-market MCCBs.

Accordingly, an aspect of the disclosed and claimed concept is to provide an improved security tag that is structured to be affixed to a questioned device and that is structured to enable a verification of genuineness of the questioned device. The security tag can be generally stated as including a substrate structured to be affixed to the questioned device, the substrate comprising a data storage area structured to store data thereon, and an identification code stored in the data storage area, the identification code can be generally stated as including a data string and a signature code, the data string being specific to the questioned device, the signature code being based at least in part upon the data string and a private key, the private key and a public key being generated contemporaneously by an asymmetric key generation algorithm, the private key and the public key corresponding with one another, the data string being structured to be subjected to a hash operation to result in a message digest, the signature code being structured to be subjected to a decryption operation with the use of the public key to result in another message digest wherein: if the message digest and the another message digest are the same, the identification code is structured to be used to verify the questioned device as being genuine, and if the message digest and the another message digest are not the same, the identification code is structured to be used to identify the questioned device as being other than genuine.

Another aspect of the disclosed and claimed concept is to provide an improved machine readable storage medium comprising a number of instructions which, when executed on a processor of an electronic device, cause the electronic device to perform operations that can be generally stated as including reading from a security tag affixed to a questioned device an identification code that comprises a data string and a signature code, the data string being specific to the questioned device, the signature code being based at least in part upon the data string and a private key, the private key and a public key being generated contemporaneously by an asymmetric key generation algorithm, the private key and the public key corresponding with one another, subjecting the data string to a hash operation to result in a message digest, subjecting the signature code to a decryption operation with the use of the public key to result in another message digest, responsive to a determination that the message digest and the another message digest are the same, verifying the questioned device as being genuine, and responsive to a determination that the message digest and the another message digest are not the same, identifying the questioned device as being other than genuine.

Another aspect of the disclosed and claimed concept is to provide an improved electronic system having a processor apparatus that comprises a processor and a storage and being structured to communicate with an electronic device regarding a security tag that comprises an identification code and that is affixed to a questioned device, the storage having stored therein a number of instructions which, when executed on the processor, cause the electronic system to perform operations that can be generally stated as including receiving from the electronic device at least a portion of the identification code, comparing the at least portion of the identification code with a revocation list that is stored in the storage and that comprises information representative of a number of devices whose genuineness has been compromised and, based at least in part upon the comparing, communicating to the electronic device a response that includes data representative of one of: the genuineness of the questioned device being confirmed, and the genuineness of the questioned device having been compromised.

### BRIEF DESCRIPTION OF THE DRAWINGS

A further understanding of the disclosed and claimed concept can be gained from the following Description when read in conjunction with the accompanying drawings in which:

FIG. 1 is a block diagram illustrating system and method to detect unauthorized tampering of MCCBs and authenticate MCCBs against counterfeiting or gray market items;

FIG. 2 is a block diagram illustrating creation of a digital signature code;

FIG. 3 is a depiction of a security tag in accordance with a first embodiment of the disclosed and claimed concept showing the contents of an identification code stored thereon;

FIG. 4 is an installation of a number of the security tags of FIG. 3 onto an MCCB;

FIG. 5 is a block diagram illustrating a number of steps to verify the identification code on the security tag of FIG. 3; and

FIG. 6 is a depiction of a security tag in accordance with a second embodiment the disclosed and claimed concept showing the contents of an identification code stored thereon, and further depicting an electronic device optically scanning the security tag and communicating the identification code to an electronic system remote therefrom.

Similar numerals refer to similar parts throughout the specification.

### DESCRIPTION

### Generate Paired Public and Private Keys

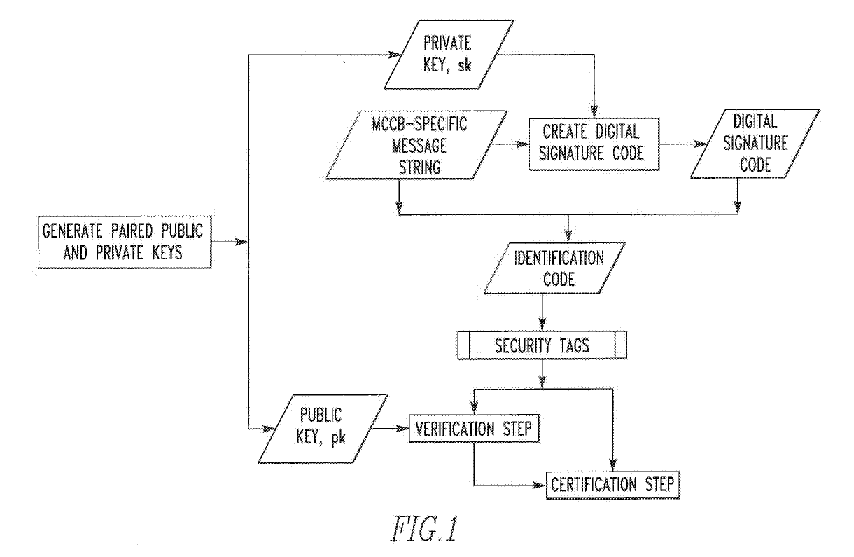

First, and as can be seen in FIG. 1, an asymmetric key generation algorithm is used to generate a public key, pk, and a corresponding private key, sk. The public key, pk, and the corresponding private key, sk, consist of large positive integers. The public key, pk, is different from the corresponding private key, sk due to the use of asymmetric key generation algorithm. The public key and the corresponding private key form paired public and private keys pk, sk.

There are a number of different asymmetric key generation algorithms that can be used to generate the paired public and private keys (IEEE Standard Specifications for Public-Key Cryptography, IEEE Std. 1363-2000, January 2000), such as RSA algorithm (R. L. Rivest, A. Shamir, and L. Adleman, “A method for obtaining digital signatures and public-key cryptosystems,” Communications of the ACM, vol. 21, no. 2, pp. 120-126, February 1978), (R. L. Rivest, A. Shamir, and L. M. Adleman, “Cryptographic communications system and method,” U.S. Pat. No. 4,405,829, Sep. 20, 1983), elliptic curve cryptography (ECC) (N. Koblitz, “Elliptic curve cryptosystems,” Mathematics of Computation, vol. 48, no. 177, pp. 203-209, January 1987), (V. S. Miller, “Use of elliptic curves in cryptography,” Lecture Notes in Computer Science, vol. 218 on Advances in Cryptology—CRYPTO 85, pp. 417-426, Springer-Verlag: New York, N.Y., USA, 1985), and digital signature algorithm (DSA) (D. W. Kravitz, “Digital signature algorithm,” U.S. Pat. No. 5,231,668, Jul. 26, 1991). Note that asymmetric key generation algorithms use mathematical formulas that currently admit no efficient solutions. In this way, anyone who gets hold of a public key, pk, cannot efficiently guess the corresponding private key, sk. When an appropriate asymmetric cryptography system is used, data encrypted with the private key, sk, from the paired public and private keys pk, sk can only be decrypted using the public key, pk, from the same paired public and private keys.

When the large positive integers in the paired public and private keys pk, sk are represented in computer number format, they take certain number of bits, such as 256 or 512 bits. A 256-bit number is smaller in size than a 512-bit number. Generally speaking, at the same level of security, paired public and private keys generated from ECC are smaller in size than those generated from the RSA algorithm. A small-sized number requires less storage and transmission time.

In this invention, an MCCB manufacturer generates paired public and private keys pk, sk, and publishes the public key, pk, openly through trustworthy channels, such as through the MCCB manufacturer's official website, or through software programs or mobile apps authorized by the MCCB manufacturer. Meanwhile, the MCCB manufacturer holds the private key, sk, and never discloses it.

The MCCB manufacturer may also choose to generate a series of unique paired public and private keys, and associate each paired set of public and private keys with MCCBs manufactured during a specific and non-overlapping time period. For example, the MCCB manufacturer may generate a total of four unique paired public and private keys: pk1, sk1, pk2, sk2, pk3, sk3, and pk4, sk4, and may
associate pk1, sk1 with MCCBs manufactured during the first quarter of a given year,
associate pk2, sk2 with MCCBs manufactured during the second quarter of the given year;
associate pk3, sk3 with MCCBs manufactured during the third quarter of the given year;
associate pk4, sk4 with MCCBs manufactured during the fourth quarter of the given year.

This limits the potential damage that a compromised private key may cause. If in the above case, the private key sk2 is inadvertently leaked out, only MCCBs manufactured during, say, the second quarter of the given year are affected. MCCBs manufactured during other time periods of the given year are not affected.

To further enhance security, the MCCB manufacturer may choose to generate even more unique paired sets of public and private keys, and associate each paired set of public and private keys with MCCBs manufactured during an even shorter and non-overlapping time period. For example, the MCCB manufacturer may choose to generate a total of 366 unique paired sets of public and private keys, and associates each paired set of public and private keys with MCCBs manufactured on each calendar day in the given year.

### Create Digital Signature Code

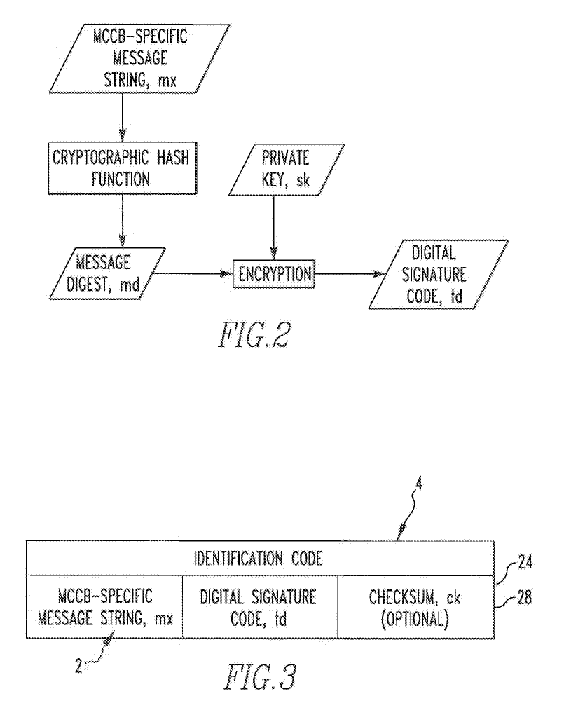

This step applies the previously generated private key, sk, to an MCCB-specific message string, mx, and produces a digital signature code, td, as an output. FIG. 2 shows a block diagram that illustrates steps to create digital signature code.

### MCCB-Specific Message String

The MCCB-specific message string, mx, is a data string in the form of a finite sequence of characters with one or more fields that uniquely identify one individual MCCB. The MCCB-specific message string mx potentially may be hundreds or thousands of characters in length. The fields of the MCCB-specific message string mx can include one or more of:
Style number
Date code
QPC code
Serial number

The serial number is a unique number associated with the MCCB.

The MCCB-specific message string, mx, may include one or more additional MCCB-related fields, such as
Region
Product website address
Service phone numbers and contact emails

The region is a string that may represent the MCCB's authorized sales region. For example, if an MCCB is intended for sale solely in the United States market, then the region string is appropriately marked with this information.

The MCCB-specific message string, mx, may further include one or more fields reserved for the MCCB manufacturer's internal use, such as
MCCB current sensor attributes
Engineering design revision numbers
A random number

The MCCB current sensor attributes and engineering design revision numbers help the MCCB manufacturer track an MCCB's engineering and design information. The random number, similar to a cryptographic nonce, is assigned by the MCCB manufacturer to each MCCB to increase the randomness of the MCCB-specific message string, mx. Because of its lack of predictability, the random number helps deter malicious decoding and interpretation of the MCCB-specific message string, mr.

### Cryptographic Hash Function

In this step, a cryptographic hash function is applied to the MCCB-specific message string, mx, and generates a message digest, md.

In this invention, the cryptographic hash function is a one-way mathematical function that converts the MCCB-specific message string, mx, into the message digest, md, which has a fixed number of bits despite its seemingly random content. One distinguishing feature of the cryptographic hash function is that it is practically infeasible to recreate the original MCCB-specific message string, mx, from the message digest, md. Another feature is that different message strings lead to different message digests.

There are a number of cryptographic hash functions that can be used to generate the message digest, md, from the MCCB-specific message string, mx. Secure hash algorithm 2 (SHA-2) (Secure Hash Standard (SHS), Federal Information Processing Standards Publication 180-4, National Institute of Standards and Technology, August 2015, Link: http://dx.doi.org/10.6028/NIST.FIPS.180-4), (G. M. Lilly, “Device for and method of one-way cryptographic hashing,” U.S. Pat. No. 6,829,355, Dec. 7, 2004), and secure hash algorithm 3 (SHA-3) (SHA-3 Standard: Permutation-Based flash and Extendable-Output Functions, Federal Information Processing Standards Publication 202, National Institute of Standards and Technology, August 2015, Link: http://dx.doi.org/l0.6028/NIST.FIPS.202), (G. Bertoni, J. Daemen, M. Peeters and G. Van Assche, The Keccak reference, round 3 submission to NIST SHA-3, 2011, http://keccak.noekeon.org/Keccak-reference-3.0.pdf) can be used. If SHA-2 is used, it can generate message digests up to 512 bits in length.

### Digital Signature Code

This step uses the private key, sk, to encrypt the message digest, md, and outputs a digital signature code, td.

Depending on the method used to generate paired public and private keys, a corresponding encryption method can be applied to produce the digital signature code, td. For example, the paired public and private keys pk, sk may be generated by the RSA algorithm. Then the public key, pk, comprises two large positive integers, e and n. The corresponding private key, sk, also comprises two large positive integers d and n, in which e≠l. It is noted that pk and sk share the same integer n. This integer n is known as the modulus in RSA algorithm.

By converting the message digest, md, to an integer, the digital signature code, td, is

td=(md)^{d} mod n (1)

where “mod” denotes a modulo, or remainder after division operation. That is, the remainder is what remains after a numerator is divided a whole number of times by a denominator. In a grossly simplified example, if md=9, d=7, and n=143, then

td=(9)⁷ mod 143=48.

The number 48 is the digital signature code. That is, (9)⁷+143=33447 plus a remainder of 48, where 48 is the digital signature code.

Because the MCCB manufacturer holds the private key, sk, and never discloses it, and because anyone who obtains the public key, pk, cannot efficiently guess the MCCB manufacturer's private key, sk, only the MCCB manufacturer can produce a valid digital signature code, td, that is tied to a specific paired set of public and private keys pk, sk. In this way, a valid digital signature code proves that the message digest was in fact created by the MCCB manufacturer. An invalid digital signature code indicates a potential forgery of either the MCCB-specific message string, or the digital signature code itself.

### Build Security Tags and Install on MCCBs

This step takes the MCCB-specific message string, mx, and its matching digital signature code, td, as inputs, and generates an identification code as its output. The identification code is programmed into one or more security tags, and installed on the MCCB.

### Identification Code

The identification code includes the following components
MCCB-specific message string, mx
Digital signature code, td
Checksum, ck

In the depicted exemplary embodiment, the MCCB-specific message string, mx, is in its original, plain-text form, and no encryption is applied to it. The digital signature code, td, is from equation 1. FIG. 3 shows the composition of such an identification code 2 as applied to a security tag 4 in accordance with a first embodiment of the disclosed and claimed concept.

The optional checksum, ck, data segment is a small segment of data that are computed from the MCCB-specific message string, mx, and the digital signature code, td, using a checksum function such as parity or cyclic redundancy check. The checksum, ck, is used to detect errors that may have been introduced during the identification code's storage or transmission. A well-designed identification code may be on the order of a few hundred to a few thousand bits.

### Security Tags

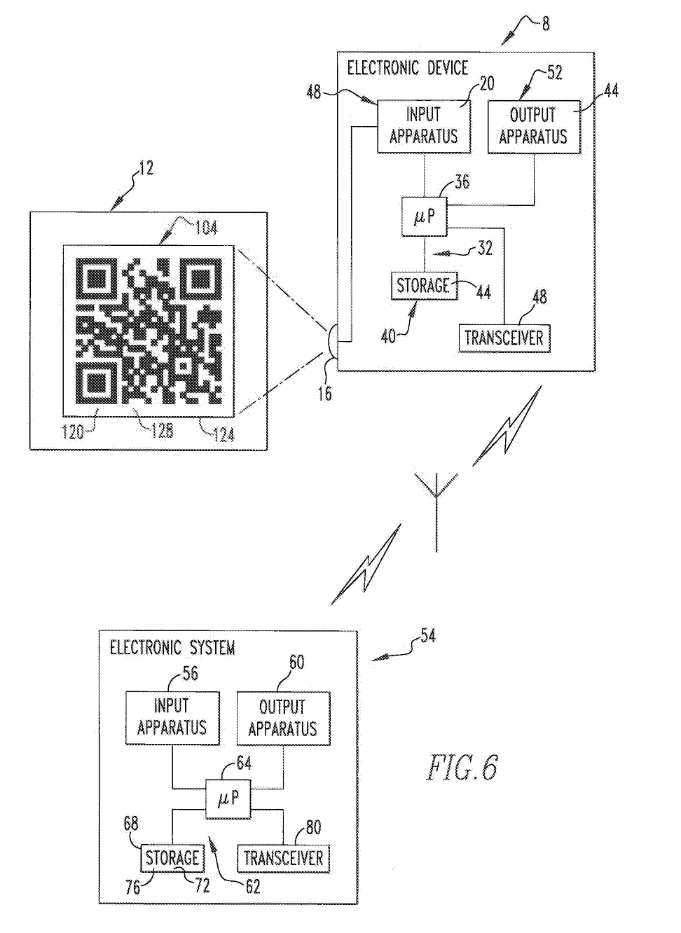

The security tag 4 serves as a storage medium for the identification code. The exemplary security tag 4 depicted in FIG. 3 is a Near-Field Communication (NFC) tag. Another security tag 104 that is in accordance with a second embodiment of the disclosed and claimed concept and which is depicted in FIG. 6 is quick response (QR) code tag. The exemplary NFC and QR security tags 4 and 104 are two exemplary types of storage media that can be used to hold the identification code, it being understood that many other types of storage media can be employed as a security tag without departing from the spirit of the disclosed and claimed concept. It is also understood that either or both of the security tags 4 and 104 can include both NFC and QR data thereon, which can be accomplished by providing two substrates for data storage, although the same can also be accomplished by using only a single such substrate to store both types of data.

The security tag 4 includes a substrate 24 upon which is situated a data storage area 28 structured to have data stored thereon and wherein the identification code is stored. The substrate 24 can be any material such as plastic, etc., upon which the storage area 28 can be disposed. The storage area is in the form of an electronic memory such as ROM or FLASH or the like without limitation. The security tag 4 also includes an antenna and other components that are well known as being a part of an NFC tag.

Near-Field Communication is a set of communication protocols that enable two electronic devices to establish communication by bringing them in close proximity, usually within a few centimeters, to each other. A typical NFC scheme involves an NFC initiator in the exemplary form of an electronic device 8, often a mobile device such as a smartphone or tablet, and a completely passive NFC tag. The NFC tag does not need any battery. Instead, the NFC tag uses the principle of electromagnetic coupling to capture a certain portion of the incident electromagnetic signal from the NFC initiator to power its electronic circuits.

The electronic device 8 includes a processor apparatus 32 that includes a processor 36 and a storage 40. The processor 36 can be any type of processor, such as a microprocessor or other processor without limitation. The storage 40 can be any type of storage such as RAM, ROM, EPROM, EEPROM, FLASH, and the like without limitation and operates as a machine readable storage medium. The storage 40 has stored therein a number of routines 44 in the form of instructions that are executable on the processor 36 to cause the electronic device 8 to perform various operations. The routines 44 include a number of algorithms such as are mentioned herein, as well as other algorithms. The electronic device 8 further includes an input apparatus 48 that provides input signals to the processor apparatus 32 and an output apparatus 52 that provides output signals to the processor apparatus 32. The output apparatus 52 includes a visual display 44 and can additionally or alternatively include other output devices such as audible output devices, tactile output devices, and the like without limitation.

In the NFC scheme, the NFC initiator generates a radio frequency (RF) field at a given frequency such as 13.56 MHz, and wirelessly transmits power through this RF field to the completely passive NFC tag via electromagnetic coupling. The NFC initiator then modulates the RF field to send commands to the passive NFC tag. In response, the NFC tag uses backward modulation to transmit data back to the NFC initiator. The NFC has been widely used in manufacturing, logistics, retail, public transit and even contactless mobile payment systems.

A QR code is a two-dimensional barcode that contains machine-readable information about the item to which it is attached. The QR code consists of black squares arranged in a square grid on a white background, and can be read and processed by a mobile device such as a smartphone or tablet. The QR code has also been widely used in manufacturing, logistics, marketing, public transit, and even landing permission stamps in passports.

Each type of media has its own advantages. For example, NFC tags are weather- and heat-resistant, and usually hold more data with a smaller footprint. In contrast, QR codes are cost effective, and can be easily duplicated. There are also limitations associated with each type of media: NFC tags are generally more expensive than QR codes, and QR codes are often difficult to scan in low-light conditions.

Either type of storage media can be used as security tags. NFC tags that are used as security tags typically require a locking operation that makes the NFC tags read-only after the identification code has been programmed into them. This is to prevent unauthorized tampering of the identification code.

### Install Security Tags on MCCB

After the identification code is programmed into it, the security tag 4 is affixed to an MCCB 12. An MCCB whose genuineness has not yet been verified or certified or both can be considered to be a questioned device. One identification code corresponds to one MCCB. Multiple security tags 4 can be installed on a single MCCB. These security tags shall hold the same identification code and thus be duplicates of one another that are limited in quantity.

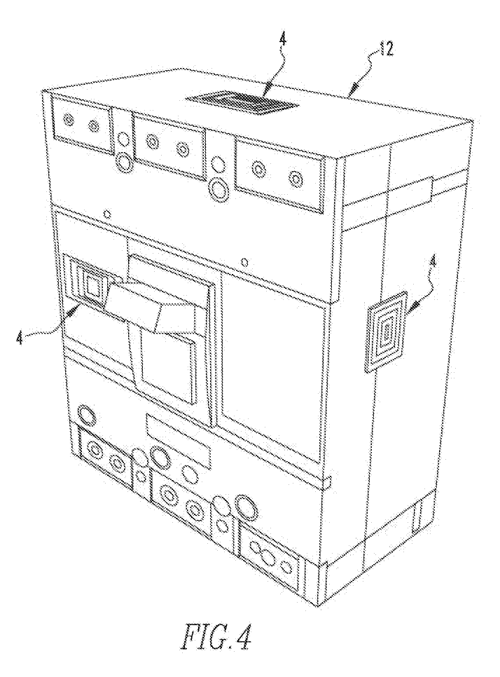

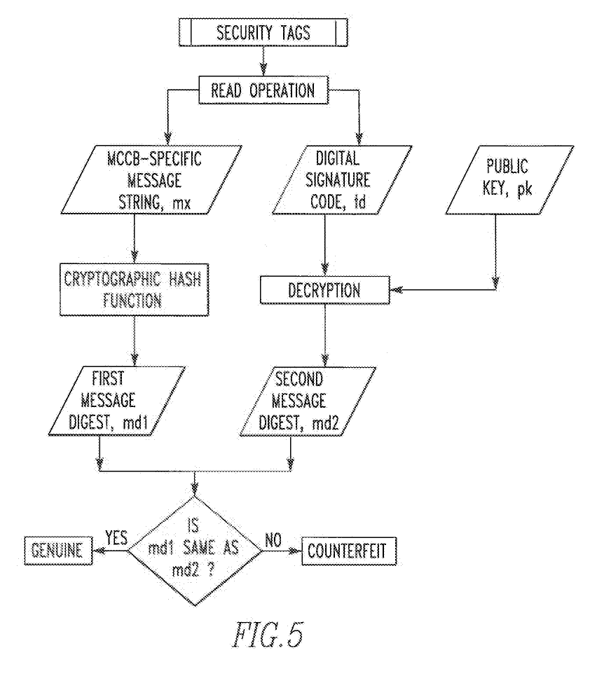

When NFC tags or QR codes are used as a part of the security tags 4, a certain orientation is required so that the identification code can be effectively read or scanned from them. To facilitate scanning and reading, multiple security tags 4 with the same identification code are typically installed onto multiple locations on the same MCCB 12. For example, in FIG. 4, a first security tag 4 can be molded into or attached to the front cover of the MCCB 12. A second security tag 4 that carries the same identification code can be molded into or attached to the right side cover of the same MCCB 12. A third security tag 4 that carries the same identification code can also be molded into or attached to the top cover of the same MCCB 12. More security tags with the same identification code can be molded into or attached to other parts of the MCCB 12 as needed, such as to the MCCB's base where the whole MCCB mechanism is attached.

In the above example, when an NFC initiator like a smartphone or tablet scans and reads the identification from the MCCB, the NFC initiator can either scan from a position that is close to the MCCB's front cover, and/or a position that is close to the MCCB's side cover. Similar scenarios also apply when QR codes are used as security tags.

### Authenticate MCCBs

The following two steps are executed sequentially to authenticate MCCBs—a verification step and a certification step.

The verification step reads the security tags and cryptographically verifies the identification code using the MCCB manufacturer's public key, pk, at the location of the MCCB 12. The certification step occurs remotely and determines whether the identification code has been previously compromised and certifies the MCCB's authenticity.

### Verification Step

The verification step involves extracting the identification code from the one or more of the attached security tags 4, and determining whether the identification code contains a valid MCCB-specific message string and a valid corresponding digital signature code by using the MCCB manufacturer's public key, pk. FIG. 5 shows detailed steps to verify the identification code.

### Read Security Tags

If an NFC tag is used as the security tag, extracting the identification code from the NFC tag is conducted on an initiator-talks-first basis. The NFC initiator, often a mobile device such as a smartphone or tablet, powers up the NFC tag wirelessly through the principle of electromagnetic coupling. Once the NFC tag is activated by the NFC initiator's signal, it waits for a command from the NFC initiator. The NFC initiator then sends the command by modulating the RF field, and NFC tag replies to this command by modulating the RF field, i.e., load modulation. The NFC initiator senses the NFC tag's modulated RF field, and interprets the response message. By repeating this process, the identification code carried in the NFC tag is extracted.

When a QR code 120 is used, such as in the security tag 104, extracting the identification code from the QR code is conducted by optically scanning the QR code. The security tag 104 includes a substrate 124 having a data storage area that is structured to have data stored thereon and that is in the exemplary form of an imprintable area 128 on which the QR code 120 is printed or otherwise applied. The substrate 124 can be any of a wide variety of paper or plastic materials or other materials that can be affixed to the MCCB 12 and upon which the QR code 120 can be imprinted. A QR scanning device is most typically incorporated on a mobile device such as the electronic device 8 or other device such as a smartphone or tablet that is equipped with a camera 16 that serves as a QR scanner that optically scans the QR code and retrieves the identification code carried in the QR code. In the depicted exemplary embodiment, the electronic device 8 further includes an NFC initiator 20 that is a part of the input apparatus 48. The NFC initiator or QR scanner can also be a dedicated device with either the NFC reader or the QR code scanner. The electronic device 8 further includes a transceiver 48 that is connected with the processor 36 and that enables the electronic device to communicate wirelessly with an electronic system 54 as will be described in greater detail below.

### Verify Identification Code

Given the identification code obtained from the security tag 4 or 104, a verification algorithm stored in the storage 40 returns “accepted” when the identification code's MCCB-specific message string and the digital signature code are considered to be a “match” as set forth in greater detail below. The verification algorithm returns “rejected” when the MCCB-specific message string and the digital signature code do not form a “match”.

If the identification code's checksum is available, then the first step is to check the identification code's integrity. The identification code's MCCB-specific message string and digital signature code are passed through the same checksum function as the one used to create the identification code. If the checksum generated in this step matches the identification code's checksum, it confirms the identification code's integrity. Otherwise, the identification code needs to be read again from the security tag to correct any errors. Note that this step can be skipped if the checksum is unavailable.

The next step is to pass the MCCB-specific message string through the same cryptographic hash function as the one used to create the digital signature code. The output of this step is a first message digest, md1.

The third step is to use the MCCB manufacturer's public key, pk, which comprises two large positive integers, e and n, in a decryption operation to decrypt the digital signature code, td, and obtain a second message digest, md2.

For example, using the RSA aforementioned algorithm, the second message digest md2 is computed via

md2=(td)^{e} mod n (2)

The MCCB manufacturer's public key, pk, shall be obtained through a trustworthy channel, such as through the MCCB manufacturer's official website, or from software programs or mobile apps authorized by the MCCB manufacturer.

The last step is to compare the first message digest, md1, to the second message digest, md2. If md1 equals md2, this is a “match” which verifies that the identification code was genuinely created by the MCCB manufacturer. If md1 is different from md2, this is not a “match”, which demonstrates that the identification code was not genuinely created by the MCCB manufacturer.

The above verification operation helps detect unauthorized product tampering. Referring to FIG. 4 when an unauthorized third-party tampers with and refurbishes MCCBs from scavenged or counterfeited parts outside of original MCCB manufacturer operated facilities, such as the front cover is refurbished from one genuine MCCB, and the side cover from another genuine MCCB, then the security tags attached to the front and side covers will not match each other. This helps detect tampering and unauthorized refurbishment of MCCBs. As such, a part of the verification operation may be to subject each of the security tags 4 or 104 on the MCCB 12 to the verification algorithm.

### Certification Step

In practice, security tags with genuine identification codes potentially may be duplicated without authorization. In this case, the unauthorized duplicated identification codes are compromised. The certification step is intended to detect unauthorized duplication of security tags by checking whether the identification code contained in the security tags has been previously compromised.

To perform a check, the identification code is compared to a list of compromised identification codes. This list is also known as the revocation list. If the identification code is found in the revocation list, then it is compromised, and the security tags that contain this identification code are also regarded as compromised. If the identification code is not found in the revocation list, then a certificate of authenticity may be shown to demonstrate that the MCCB is genuine. The certificate of authenticity can be communicated to users such as via a message displayed in the software programs or mobile apps, an email, or a text message.

The electronic system 54 noted above is remote from the electronic device 8, whether by being separated by a few meters or by being separated by thousands of miles. The electronic system 54 includes an input apparatus 56, an output apparatus 60, and a processor apparatus 62. The input apparatus 56 provides input signals to the processor apparatus 62, and the output apparatus 60 receives output signals from the processor apparatus 62. The processor apparatus 62 includes a processor 64 and a storage 68 that are in communication with one another. The processor 64 can be any of a wide variety of processing devices, such as a microprocessor or other such processor. The storage 68 can be any of a wide variety of storage devices such as are noted elsewhere herein. The storage 68 has stored therein a number of routines 72 that are in the form of instructions that are executable on the processor 64 to cause the electronic system 54 to perform certain operations. The storage 68 further has a revocation list 76 stored therein. The electronic system 54 further includes a transceiver 80 that enables it to communicate wirelessly or in other ways to or with the electronic device 8.

The revocation list 76 is compiled from a number of sources, such as NFC initiator or QR scanner's device-specific data, and geographic locations (if available) associated with the NFC initiator or QR scanner. The revocation list 76 can be hosted at an MCCB manufacturer-owned server, or a third-party server authorized by the MCCB manufacturer, and is constantly updated. To perform an identification code check, an online access from the NFC initiator 20 or QR scanner 16 of the electronic device 8, via the transceivers 48 and 80, to the revocation list 76 is required.

The verification and certification steps can be used to detect potential gray market MCCBs. In this case, the geographic location of the NFC initiator or QR scanner is regarded as the actual geographic location of the scanned MCCB, and the actual geographic location is compared with the region field extracted from the identification code's MCCB-specific message string. The region field identifies the intended geographic location for the MCCB. If the geographic location does not agree with the region field, then the MCCB can be marked as a potential gray market item. For example, if the geographic location indicates that the MCCB is located in a country in North America, while the region field indicates that the MCCB is intended for sale solely in Europe, the Middle East and Africa market, then the MCCB can be marked as a potential gray market item for further investigation, and this may include adding to the revocation list 76 a data entry indicating that the security tag 4 is or may be compromised. Likewise, if the same security tag 4 is allegedly identified in two different geographic locations, this could indicate that the security tag 4 was copied and thus is compromised. Similarly, if the same identification code has been received more than a predetermined number of times within a predetermined period of time, this could indicate that the security tag 4 was copied and thus is compromised.

At the end of the certification operation, the electronic system 54 can communicate to the electronic device 8 a data file that includes a set of market data that includes either that the actual geographic location of the questioned device is legitimate or that the actual geographic location of the questioned device is illegitimate.

In addition to detecting unauthorized tampering and potential gray market MCCBs, the verification and certification steps can also be used to detect counterfeit MCCBs. In this case, because counterfeiters do not possess the MCCB manufacturer's private key, sk, they cannot forge valid identification codes. The MCCBs produced by counterfeiters either do not have valid identification codes, or they have a valid but compromised identification code that is duplicated from a genuine MCCB. In the former case, it is easy to detect the absence of valid identification codes using NFC initiators or QR scanners. In the latter case, when the valid but compromised identification code is checked against the revocation list, the counterfeit MCCBs can also be detected.

By incorporating digital signature codes into MCCBs, this invention provides traceability of original MCCB manufacturer's products. Successful verification and certification give users confidence to trust the MCCBs' integrity and authenticity. Users can further identify whether the MCCBs are potential gray market items by examining the contents of valid identification codes.

Through the use of NFC tags and initiator, or QR codes and scanners, this invention automates the verification and certification process. Through the use software programs or mobile apps, this invention also provides easy-to-navigate verification and certification processes to the users. In this way, this invention helps reduce the amount of effort that ordinary users have to spend when determining the MCCB's integrity and authenticity. This further helps eliminate risks, liabilities, safety- and performance-related issues, and even a complete business shutdown that may occur when using tampered, counterfeit, or gray-market MCCBs.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A security tag that is structured to be affixed to a questioned device and that is structured to enable a verification of genuineness of the questioned device, the security tag comprising:
a substrate structured to be affixed to the questioned device, the substrate comprising a data storage area structured to store data thereon; and
an identification code stored in the data storage area, the identification code comprising a data string and a signature code, the data string being specific to the questioned device, the signature code being based at least in part upon the data string and a private key, the private key and a public key being generated contemporaneously by an asymmetric key generation algorithm, the private key and the public key corresponding with one another, the data string being structured to be subjected to a hash operation to result in a message digest, the signature code being structured to be subjected to a decryption operation with the use of the public key to result in another message digest wherein:
if the message digest and the another message digest are the same, the identification code is structured to be used to verify the questioned device as being genuine, and
if the message digest and the another message digest are not the same, the identification code is structured to be used to identify the questioned device as being other than genuine.

2. The security tag of claim 1 wherein the substrate comprises a Near Field Communication (NFC) tag that is structured to wirelessly communicate the identification code to an electronic device, the NFC tag having as the data storage area an electronic data storage area.

3. The security tag of claim 1 wherein the substrate comprises a label that is optically readable by another machine to communicate the identification code to the another machine, the label having as the data storage area an imprintable area, and the identification being in the form of imprinted subject matter.

4. The security tag of claim 1 wherein the data string comprises data that is representative of a serial number of the questioned device and at least one of:
a style number of the questioned device;
a date code of the questioned device;
a geographical region where the questioned device can be sold;
a website address related to the questioned device;
a telephone number for service related to the questioned device;
an email for service related to the questioned device;
a number of sensor attributes of the questioned device;
an engineering design revision number of the questioned device; and
a random number.

5. The security tag of claim 4 wherein the signature code is obtained from an encryption algorithm having as inputs the private key and a data digest, the data digest resulting from the data string having been subjected to the said hash operation.

6. The security tag of claim 4 wherein the identification code further comprises a checksum data segment that is based at least in part upon the data string and the signature code being subjected to a checksum operation, and wherein the checksum data segment is structured to be usable to detect whether an error occurred in at least one of communication of the identification code to the security tag and storage of the identification code in the data storage area.

7. A machine readable storage medium comprising a number of instructions which, when executed on a processor of an electronic device, cause the electronic device to perform operations comprising:
reading from a security tag affixed to a questioned device an identification code that comprises a data string and a signature code, the data string being specific to the questioned device, the signature code being based at least in part upon the data string and a private key, the private key and a public key being generated contemporaneously by an asymmetric key generation algorithm, the private key and the public key corresponding with one another,
subjecting the data string to a hash operation to result in a message digest;
subjecting the signature code to a decryption operation with the use of the public key to result in another message digest;
responsive to a determination that the message digest and the another message digest are the same, verifying the questioned device as being genuine; and
responsive to a determination that the message digest and the another message digest are not the same, identifying the questioned device as being other than genuine.

8. The machine readable storage medium of claim 7 wherein the operations further comprise outputting on the electronic device an indication representative of the determination.

9. The machine readable storage medium of claim 7 wherein the operations further comprise employing Near Field Communication (NFC) data communications to wirelessly communicate the identification code to the electronic device.

10. The machine readable storage medium of claim 7 wherein the operations further comprise optically reading the identification code from the security tag.

11. The machine readable storage medium of claim 7 wherein the identification code further comprises a checksum data segment that is based at least in part upon the data string and the signature code being subjected to a checksum operation, and wherein the operations further comprise using the checksum data segment to detect whether an error occurred in at least one of communication of the identification code to the security tag and storage of the identification code on the security tag.

12. The machine readable storage medium of claim 7 wherein the operations further comprise performing a certification operation comprising:
communicating at least a portion of the identification code to an electronic system for comparison with a revocation list that comprises information representative of a number of devices whose genuineness has been compromised;
receiving from the electronic system a response that includes data representative of at least one of:
the genuineness of the questioned device being confirmed, and
the genuineness of the questioned device having been compromised; and
outputting on the electronic device an indication representative of the response.

13. The machine readable storage medium of claim 12 wherein the operations further comprise:
communicating data representative of an actual geographic location of the questioned device to the electronic system for comparison of the actual geographic location with an intended geographic location of the questioned device; and
receiving from the electronic system as part of the response a set of market data that is representative of at least one of:
the actual geographic location of the questioned device being legitimate, and
the actual geographic location of the questioned device indicating a gray market sale; and
outputting on the electronic device an indication representative of the set of market data.

14. An electronic system having a processor apparatus that comprises a processor and a storage and being structured to communicate with an electronic device regarding a security tag that comprises an identification code and that is affixed to a questioned device, the storage having stored therein a number of instructions which, when executed on the processor, cause the electronic system to perform operations comprising:
receiving from the electronic device at least a portion of the identification code;
comparing the at least portion of the identification code with a revocation list that is stored in the storage and that comprises information representative of a number of devices whose genuineness has been compromised; and
based at least in part upon the comparing, communicating to the electronic device a response that includes data representative of one of:
the genuineness of the questioned device being confirmed, and
the genuineness of the questioned device having been compromised.

15. The electronic system of claim 14 wherein the operations further comprise:
receiving from the electronic device data representative of an actual geographic location of the questioned device;
making a comparison of the actual geographic location with an intended geographic location of the questioned device; and
based at least in part upon the comparison, sending to the electronic system as part of the response a set of market data that is representative of one of:
the actual geographic location of the questioned device being legitimate, and
the actual geographic location of the questioned device indicating a gray market sale.

16. The electronic system of claim 15 wherein the operations further comprise:
sending to the electronic system as part of the response a set of market data that is representative of the actual geographic location of the questioned device indicating a gray market sale; and
adding to the revocation list a data entry that is representative of the at least portion of the identification code.

17. The electronic system of claim 14 wherein the operations further comprise:
making a determination that the at least portion of the identification code has been received by the electronic system more than a predetermined number of times within a predetermined period of time; and
responsive to the determination, adding to the revocation list a data entry that is representative of the at least portion of the identification code.

18. A molded case circuit breaker having a plurality of the security tags of claim 1 situated thereon.

19. The molded case circuit breaker of claim 18 wherein the manufacturer of the molded case circuit breaker generates a series of unique paired public and private keys, and associates each paired set of public and private keys with all molded case circuit breakers manufactured during a specific and non-overlapping time period.
